(19) United States
(12) Patent Application Publication
(10) Pub. No.: US 2023/0115140 A1
(43) Pub. Date: Apr. 13, 2023

(54) RETRACTABLE READ-ONLY ELECTRONIC MAIL

(71) Applicant: BANK OF AMERICA CORPORATION, Charlotte, NC (US)

(72) Inventors: George Anthony Albero, Charlotte, NC (US); Maharaj Mukherjee, Poughkeepsie, NY (US); Benjamin Moores, Ventura, CA (US)

(73) Assignee: BANK OF AMERICA CORPORATION, Charlotte, NC (US)

(21) Appl. No.: 17/497,360

(22) Filed: Oct. 8, 2021

(51) Int. Cl. H04L 12/58

(52) U.S. Cl. CPC H04L 51/18; H04L 51/30

(57) ABSTRACT

Access to electronic mail is controlled on a per-email recipient basis via use of a cloud computing model. Email assigned to be access controlled are communicated from an email application to the cloud computing model at which access control rules are applied on a per-email recipient basis. Once the cloud computing model has applied the access control rules, the email is communicated to the recipient's inbox with inclusion of an appropriate indicator that indicates that the email is subject to access control and/or the specific type(s) of access control. Once the email recipient opens the email, the email is not downloaded to the email recipient's client, but rather is visible to the email recipient via the cloud storage. As a result, since the email remains in the cloud and is not stored either at the email recipient's email server or client, the ability exists within the cloud computing model to control access to the email.

### FIELD OF THE INVENTION

The present invention is generally related to electronic communication and, more specifically, controlling access to electronic mail (i.e., email) through use of cloud storage, which allows an email recipient access to email per defined rules without allowing for downloading of the email to the email recipient's client or an email server associated with the email recipient's domain.

### BACKGROUND

Remote work environments have become common place. Typically, when the remote worker experiences computing problems related to the ability of their computing device, to connect to a computing network (e.g., the employer's intranet or the like) or services offered therein (e.g., email, desktop productivity applications and the like), the remote worker will contact their respective Information Technology (IT) personnel to address the problem. However, in such instances the IT personnel are typically limited to making server-side checks, which may not indicate a problem if, in fact, the issue causing the problem is at the client-side.

Moreover, while systems and method are in place to proactively monitor network and service connectivity/availability at the server-side and address issues arising from such monitoring, no such systems or methods exist to monitor network and service connectivity/availability from the client-side and proactively address issues that would arise from such monitoring (i.e., failure at network segments, routing issues at the client0side and the like).

Therefore, a need exists to develop systems, computer-implemented methods, and the like for monitoring from the client-side network and service connectivity and availability and, proactively addressing issues that result from such monitoring. As a result, the desired systems, computer-implemented methods and the like should resolve problems before they ever become apparent to the users (i.e., remote workers or the like) and, thus, lessen the need for the users to reach out to IT personnel to address an existing network or service connectivity/availability problem.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by controlling access to electronic mail on a per-email recipient basis via use of a cloud computing model. Specifically, email assigned to be access controlled are communicated to the cloud computing model, instead of the email server of the recipient's domain, where access control rules are applied on a per-email recipient basis. Access control rules include, but are not limited to, (i) read-only (i.e., no forwarding, no printing and the like), (ii) retractable on-demand or after expiration of a predefined time period, and (iii) redaction of designated portions of the email and the like.

Access control occurs on a per-email recipient basis; meaning that each email recipient may be subjected to different access control rules. For example, certain email recipients may have one portion of an email redacted, while other email recipients have other portions of the email redacted. Further, certain email recipients may be designated for email retraction after expiration of one time period, while other email recipients may be designated for email retraction after expiration of another time period.

Once the cloud computing model has applied the access control rules, the email is communicated to the recipient's inbox with inclusion of an appropriate indicator (e.g., banner, time clock or the like) that indicates that the email is subject to access control and/or the specific type(s) of access control. When the email recipient opens the email, the email is not downloaded to the email recipient's client (or the email domain server), but rather is visible to the email recipient via the cloud storage. As such, since the email remains in the cloud and is not stored either at the email recipient's email server or client, the ability exists to control access to the email (i.e., ensure the email is not forwarded, printed or the like, retract the email even after the recipient has opened the email and the like).

In specific embodiments of the invention, the access control rules are defined by the email sender at the time of email generation and communicated to the cloud computing model via the email header. While in other specific embodiments of the invention, the access control rules may exist within the cloud computing model, such that the cloud computing model identifies specific email recipients that are subject to access control rules and applies the rules to emails addressed to such email recipients.

In specific embodiments of the invention, the email management application is an off-the-shelf application with plug-ins to accommodate access-controlled emails. Such that once the email sender designates an email for access control, Application Programming Interfaces (APIs) are invoked that subsequently communicate the email to the cloud computing model as opposed to the email domain server(s). In other embodiments of the invention, the email management application is a stand-alone application that is configured for exclusive generation and communication of access-controlled emails to the cloud computing model.

In further embodiments of the invention, once the access-controlled email has been opened and is visible to the email recipient, the cloud computing model can monitor specific functions on the client device to ensure that the email recipient is not violating access control restrictions. For example, in the event that the email is subject to read-only access control, the cloud computing model may monitor for a user input that initiates a print screen function (e.g., activation of certain keys on the keyboard) and, in response to detection, revoke/retract the user's access to the email. Such monitoring of the email recipient's client is made possible by the live tunnel-like connection provided between the cloud-stored email and the client.

A system for controlling access to electronic mail (email) defines first embodiments of the invention. The system includes an email management application, which may be a customized off-the-shelf application or a standalone application (e.g., configured only for communicating access-controlled emails). The email management application is configured to provide for an email sender to generate an email addressed to one or more email recipients and communicate the email to a cloud computing model. The system additional includes the cloud computing model that comprises cloud storage and one or more cloud processors in communication with the cloud storage. The cloud computing model is configured to receive and store in the cloud storage the email communicated from the email management application. Further, the cloud computing model is configured to implement the one or more cloud processors to (i) determine access control rules for the email on a per-email recipient basis, and (ii) apply the access controls rules to the email, including adding one or more access control indicators to the email that provide visual or audible indication to the email recipients that the email is subject to one or access controls. In response to applying the access control rules to the email, the cloud computing model is further configured to communicate an email notification to one or more email inboxes, each of the one or more email inboxes associated with an email address of one of the one or more email recipients.

In response to the one or more email recipients opening the email notification from their associated inbox, each email recipient is able to access the email from the cloud storage in accordance with the email recipient-specific access controls rules and the email is not downloaded from the cloud storage or allowed to be downloaded from the cloud storage to any (i) client of the email recipient, and (ii) email server associated with a domain of the email recipient. In this regard, the email exists only within in the cloud storage and never at the client or recipient's email server.

In specific embodiments of the system, the access controls rules include (i) designation of the email as read-only, wherein read-only includes not being able to forward or print the email, (ii) designation of the email as at least one selected from the group consisting of (a) retractable on-demand by the email sender, and (b) retraction after expiration of a predetermined time period, and/or (iii) redaction of designated portions of the email. In those embodiments of the invention, in which the access control rule is retraction after expiration of a predetermined time period, the access control indicators may include a running time keeper that is configured to dynamically indicate a time before expiration of the predetermined time period.

In those embodiment of the system, in which the access control rules include redaction of designated portions of the email, the designated portions of the email are designated by the email sender and (i) highlighted as the designated portion in a body of the email communicated to the cloud computing model, and/or (ii) included as metadata in a header of the email. In other embodiments of the system, the cloud computing model that is configured to implement the one or more cloud processors to determine the designated portions of the email to be redacted on a per-email recipient basis by: (a) accessing (i) a first database that stores a data restriction classification for each email recipient to identify the data restriction classification of each email recipient, and (ii) a second database that stores email content sensitivity classifications to identify sensitivity classifications of content in the email, and (b) determining the designated portions of the email on a per-email recipient basis based on the identified (i) data restriction classifications of each email recipient and (ii) the sensitivity classifications of content in the mail.

In still further embodiments of the system, the email management application is further configured to provide for a graphical user interface that includes a selectable access control option, wherein selection of the access control option provides for the email to be communicated to the cloud computing model instead of one or more email servers associated with domains of the one or more email recipients. In specific such embodiments of the system, the email management application is further configured to, in response to the email sender selecting the access control option, presenting one or more user interfaces configured for selecting access control rules on a per-email recipient basis, and, in response to the email sender selecting the access control rules, including the access control rules as metadata in a header of the email prior to communicating the email to the cloud computing model.

Moreover, in additional specific embodiments of the system, the cloud computing model is further configured to, in response to the email recipient accessing the email from the cloud storage, monitor the actions performed by the email recipient on the client, and, in response to determining that one or more of the monitored actions are in conflict with the access control rules, revoke the email recipient's access privilege to the email.

In additional specific embodiments of the system, the email management application is further configured to provide for the email sender to revise or revoke the access control rules applied to the email, and, in response to the email sender revising or revoking the access controls, communicate commands to the cloud computing model that are configured to revise or revoke the access control rules.

A computer-implemented method for controlling access to emails defines second embodiments of the invention. The computer-implemented method is executed by one or more processing devices. The computer-implemented method includes generating, within an email management application via email sender inputs, an email addressed to one or more email recipients and communicating the email to a cloud computing model. The method further includes receiving, by the cloud computing model, the email and storing the email in cloud storage. In addition, the method includes implementing one or more cloud processors to (i) determine access control rules for the email on a per-email recipient basis, (ii) apply the access controls rules to the email, and (iii) including one or more access control indicators in the email that indicate to the one or more email recipients that the email is subject to one or access controls. In response to applying the access control rules to the email and including the one or more access control identifiers, the method further includes communicating an email notification associated with the email to one or more email inboxes, each of the one or more email inboxes associated with an email address of one of the one or more email recipients. In response to the one or more email recipients opening the email from their associated inbox, each email recipient is only able to access the email from the cloud storage in accordance with the email recipient-specific access controls rules and the email is not downloaded from the cloud storage or allowed to be downloaded from the cloud storage to any (i) client of the email recipient, and (ii) email server associated with a domain of the email recipient.

In specific embodiments of the computer-implemented method, implementing one or more cloud processors to determine access control rules for the email on a per-email recipient basis further defines the access controls rules as at least one selected from the group consisting of (i) read-only, (ii) retractable on-demand by the email sender, (iii) retraction after expiration of a predetermined time period, and (iv) redaction of designated portions of the email.

In other specific embodiments of the computer-implemented method, generating the email further includes presenting, within the email management application, for a selectable access control option and receiving an input, by the email sender, that selects the access control option. In response to receiving the input that selects the access control option, the method further includes (i) configuring the email for communication to the cloud computing model instead of one or more email servers associated with domains of the one or more email recipients, and (ii) presenting, within the email management application, selectable access control rules. In response to the email sender selecting the access control rules for each of the one or more email recipients, the method further comprises including the access control rules as metadata in a header of the email prior to communicating the email to the cloud computing model.

In still further specific embodiments, the computer-implemented method includes, in response to the email recipient accessing the email from the cloud storage, monitoring the actions performed by the email recipient on the client, and, in response to determining that one or more of the monitored actions are in conflict with the access control rules, revoking the email recipient's access privilege to the email.

A computer program product including a non-transitory computer-readable medium defines third embodiments of the invention. The non-transitory computer-readable medium includes a first set of codes for causing a computer to receive email sender inputs that generate, within an email management application, an email addressed to one or more email recipients, and a second set of codes for causing a computer to communicate the email to a cloud computing model. The computer-readable medium further includes a third set of codes for causing a computer to receive, by the cloud computing model, the email and store the email in cloud storage, and a fourth set of codes for causing a computer to implement one or more cloud processors to (i) determine access control rules for the email on a per-email recipient basis, and (ii) apply the access controls rules to the email. Moreover, the computer-readable medium includes a fifth set of codes for causing a computer to include one or more access control indicators in the email that indicate to the one or more email recipients that the email is subject to one or access controls, and a sixth set of codes for causing a computer to, in response to applying the access control rules to the email and including the one or more access control identifiers, communicate an email notification associated with the email to one or more email inboxes, each of the one or more email inboxes associated with an email address of one of the one or more email recipients. In response to the one or more email recipients opening the email notification from their associated inbox, each email recipient is able to access the email from the cloud storage in accordance with the email recipient-specific access controls rules and the email is not downloaded from the cloud storage or allowed to be downloaded from the cloud storage to any (i) client of the email recipient, and (ii) email server associated with a domain of the email recipient.

In specific embodiments of the computer program product, the access controls rules are at least one selected from the group consisting of (i) read-only, (ii) retractable on-demand by the email sender, (iii) retraction after expiration of a predetermined time period, and (iv) redaction of designated portions of the email.

In other specific embodiments of the computer program product, the first set of codes is further configured to cause the computer to (i) present, within the email management application, for a selectable access control option, (ii) receive an input, by the email sender, that selects the access control option, and (iii) in response to receiving the input that selects the access control option, (a) configuring the email for communication to the cloud computing model instead of one or more email servers associated with domains of the one or more email recipients, and (b) presenting, within the email management application, selectable access control rules; and (iv) in response to the email sender selecting the access control rules for each of the one or more email recipients, including the access control rules as metadata in a header of the email prior to communicating the email to the cloud computing model.

In still further specific embodiments of the computer program product, the computer-readable medium further includes a seventh set of codes for causing a computer to, in response to the email recipient accessing the email from the cloud storage, monitor the actions performed by the email recipient on the client, and an eighth set of codes for causing a computer to, in response to determining that one or more of the monitored actions are in conflict with the access control rules, revoke the email recipient's access privilege to the email.

Thus, according to embodiments of the invention, which will be discussed in greater detail below, the present invention addresses needs and/or achieves other advantages by providing for access control of emails. Specifically, the present invention applies access control rules on a per-email recipient basis at a cloud computing model, such that the emails are only accessible to the email recipient via the cloud. Thus, the emails do exist on the email server or client of the email recipient. Access rules may include, but are not limited to, (i) read-only, (ii) retractable on demand by the email sender, (iii) retraction after expiration of a predefined time period, (iv) redaction of predefined portions of the email and the like. The email appears in the email recipient's inbox with one or more identifiers that indicate that the email is subject to access control. Moreover, since access is controlled within the cloud computing model, access rules may dynamically be revised by the email sender after the email has been sent to accommodate the needs of the email sender.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block of a system for providing controlled access to electronic mail, in accordance with embodiments of the present invention;

FIG. 2 is a block diagram of an email sender's client including an email management application, in accordance with embodiments of the present invention;

FIG. 3 is a block diagram of cloud computing model configured to manage access control for emails, in accordance with alternate embodiments of the present invention;

FIG. 4 is a flow diagram of a method for controlling access to emails, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform may include a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that provide for controlling access to electronic mail, on a per-email recipient basis, via use of a cloud computing model. Specifically, email assigned to be access controlled are communicated to the cloud computing model, instead of the email server of the recipient's domain, where access control rules are determined and applied on a per-email recipient basis. Access control rules include, but are not limited to, (i) read-only (i.e., no forwarding, no printing and the like), (ii) retractable on-demand or after expiration of a predefined time period, and (iii) redaction of designated portions of the email and the like.

Access control occurs on a per-email recipient basis; meaning that each email recipient may be subjected to different access control rules. For example, certain email recipients may have one portion of an email redacted, while other email recipients have other portions of the email redacted. Further, certain email recipients may be designated for email retraction after expiration of one time period, while other email recipients may be designated for no email retraction or retraction after expiration of another time period.

Once the cloud computing model has applied the access control rules, the email is communicated to the recipient's inbox with inclusion of an appropriate indicator (e.g., banner, time clock or the like) that indicates that the email is subject to access control and/or indicates the specific type(s) of access control. When the email recipient opens the email, the email is not downloaded to the email recipient's client (or the email domain server), but rather is visible to the email recipient via the cloud storage. As such, since the email remains in the cloud and is not stored either at the email recipient's email server or client, the ability exists to control access to the email (i.e., ensure the email is not forwarded, printed or the like, retract the email even after the recipient has opened the email and the like).

In specific embodiments of the invention, the access control rules are defined by the email sender at the time of email generation and communicated to the cloud computing model via the email header. While in other specific embodiments of the invention, the access control rules may exist within the cloud computing model, such that the cloud computing model identifies specific email recipients that are subject to access control rules and applies the rules to such email recipients.

In specific embodiments of the invention, the email management application is an off-the-shelf email management application with plug-ins to accommodate access-controlled emails. Such that once the email sender designates an email for access control, Application Programming Interfaces (APIs) are invoked that subsequently communicate the email to the cloud computing model as opposed to the email domain server(s). In other embodiments of the invention, the email management application is a stand-alone application that is configured for exclusive generation and communication of access-controlled emails to the cloud computing model.

In further embodiments of the invention, once the access-controlled email has been opened and is visible to the email recipient, the cloud computing model can monitor specific functions on the client device to ensure that the email recipient is not violating access control restrictions. For example, in the event that the email is subject to read-only access control, the cloud computing model may monitor for a user input that initiates a print screen function (e.g., activation of certain keys on the keyboard) and, in response to detection, revoke/retract the user's access privileges to the email.

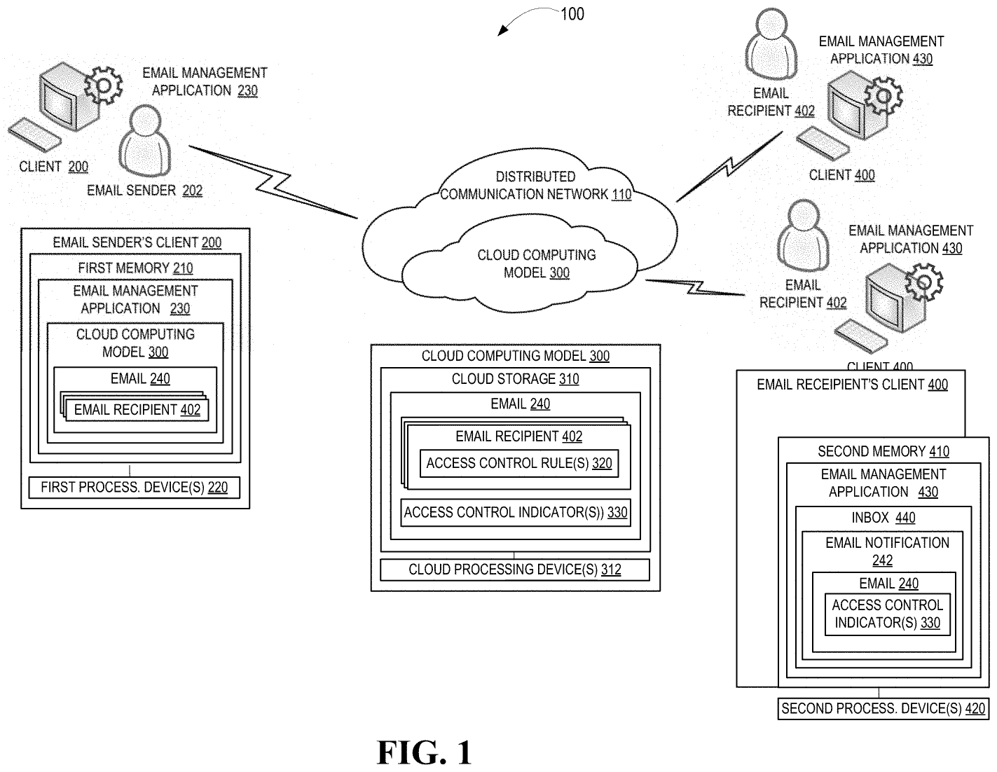

Referring to FIG. 1, a schematic/block diagram is presented of a system 100 for controlling access to electronic mail (email), in accordance with embodiments of the present invention. The system 100 is implemented within a distributed communication network 110 that may include the Internet, one or more intranets, one or more cellular networks, one or more short-range wireless networks or the like.

The system includes an email management application 230 that is stored in first memory 210 of email sender's client 200. The email management application is executable by one or more first processing devices 220 and is configured to receive email sender 202 inputs that generate an email 240 that is addressed to one or more email recipients 402. Email 240 as used herein includes the email itself, as well as, any attachments to the email. Further, the email management application is configured to communicate the email 240 to a cloud computing model 300, otherwise referred to as a cloud or cloud computing environment. In specific embodiments of the invention, the email management application 230 is a stand-alone email management application in which all emails 240 generated are configured for communication to the cloud computing model 300 (i.e., all emails generated are subject to access control). In other embodiments of the invention, the email management application 230 is an off-the-shelf email management application with plug-ins to accommodate access-controlled emails. In such embodiments of the system, the email management application 230 is configured with one or more selectable options for an email sender 202 to choose to generate an access-controlled email 240. In such embodiments of the system, selection of the access control option by the email sender 202 is configured to activate specified Application Programming Interfaces (APIs) that are configured to communicate the email 240 to the cloud computing model 300, as opposed to the email servers associated with the email recipient's domain.

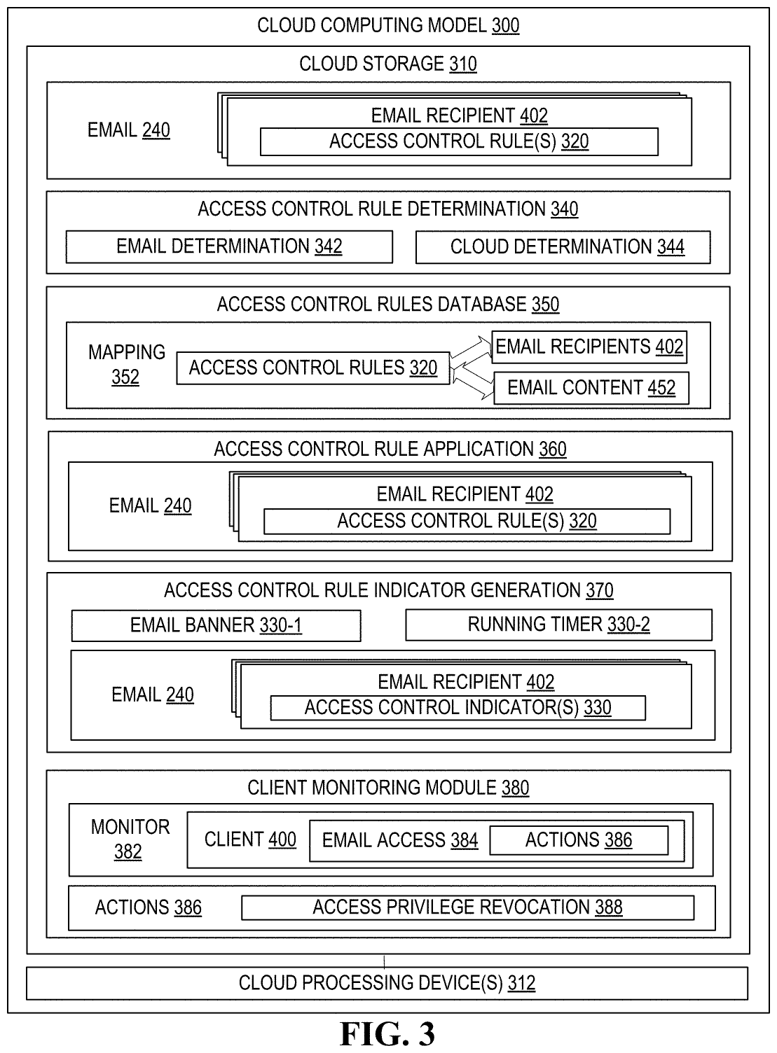

The system 100 additionally includes cloud computing model 300 that includes cloud storage 310 (i.e., cloud memory) and one or more cloud processing devices 312 in communication with the cloud storage 310. The cloud computing model 300 is configured to receive the email 240 communicated from the email sender's client 200 and implement the cloud processing device(s) 312 to determine access control rules 320 for the email on a per-email recipient basis and apply the determined rules to the email. In specific embodiments of the system, access control rules 320 are defined by the email sender 202 on a per-email recipient basis when generating the email 240 and, as such, are included, within the header (as metadata) or body (e.g., redacted portions) of the email 240. In such embodiments of the invention, determination/identification of the access control rules 240 is made by reading the header and/or body email 240. In other specific embodiments of the invention, as discussed in more details infra, in relation to FIG. 3, one or more of the access control rules may be determined at the cloud computing model 300. For example, the cloud computing model 300 may store or have access to a database that maps email recipients 402 to access control rules 320. In such embodiments of the invention, the cloud computing model determines access control rules 320 based on which email recipients 402 are assigned (i.e., mapped) to which access control rules 320.

Additionally, cloud processing device(s) 312 are implemented to generate and include one or more access control indicators 330 in the email 240 that indicate that the email is accessed control and, in some embodiments the type(s) of access control that the email is subjected to. For example, the access control indicator 330 may be a banner included within the body of the email that indicates that the email is access controlled (e.g., read-only or the like). In other embodiments of the system, the access control indicator may be a dynamic running timer that indicates the current amount of time remaining before the email is retracted or the like.

In response to applying the access control rules to the email and including one or more access control indicators in the email, the cloud computing model is further configured to initiate communication of an email notification 242 associated with the email 240 to one or more email inboxes 440 associated with the email addresses of the one or more email recipients 402.

In response to the one or more email recipients 402 accessing their inbox 440 from within their respective email management application 430 (which be the same or a different email management application than the one utilized by the email sender 202) stored within second memory 410 of email recipient's client 400 and opening the email notification 242, each email recipient 400 is provided access to the email 240 from the cloud storage 310 in accordance with email recipient-specific access control rules (i.e., the email recipient 402 is viewing the email stored/hosted on the cloud storage 310). However, unlike conventional email, the email is not downloaded nor downloadable from the cloud storage to the email recipient's client 400 or any email server associated with the domain of the email recipient 400. By not having the email 240 exist within the second memory 410 of the email recipient's client 400, the present invention is able to control access (e.g., ensure that the email is retractable even after the email recipient has opened the email notification 242 and read the email 240, ensure that the email cannot be forwarded or printed (i.e., read-only) and the like).

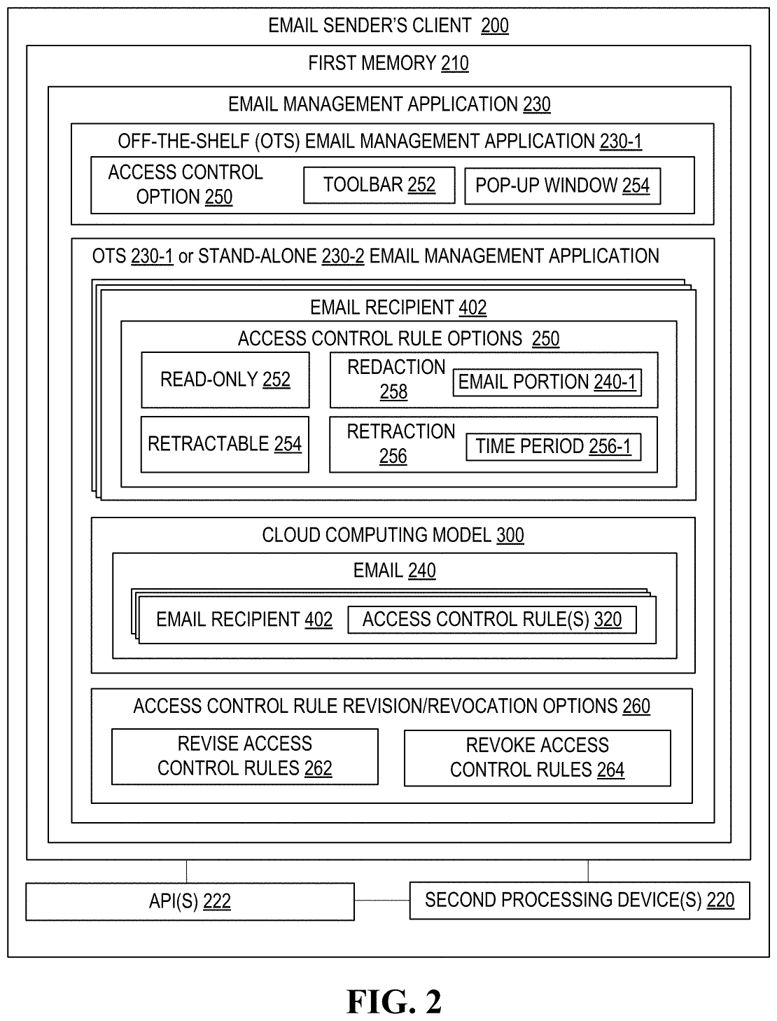

Referring to FIG. 2 a block diagram is present of an email sender's client 200, in accordance with embodiments of the present invention. In addition to highlighting details of the email management application 230, FIG. 2 describes various alternate embodiments of the invention. Client 200 comprises one or more computing devices/apparatus, such as a personal computer, mobile communication device or the like configured to execute software programs, including instructions, engines, algorithms, modules, routines, applications, tools, and the like. Client 200 includes first memory 210, which may comprise volatile and non-volatile memory, EPROM, EEPROM, or any memory common to computer platforms. Moreover, second memory 210 may comprise cloud storage, such as provided by a cloud storage service and/or a cloud connection service.

Further, client 300 also includes second processing device(s) 220, which may be an application-specific integrated circuit (“ASIC”), or other chipset, logic circuit, or other data processing device. Second processing device(s) 220 may execute an application programming interface (“API”) 222 that interfaces with any resident programs, such as email management application 230 and algorithms, sub-engines/routines associated therewith or the like stored in first memory 210 of client 200.

First processing device(s) 220 may include various processing subsystems (not shown in FIG. 2) embodied in hardware, firmware, software, and combinations thereof, that enable the functionality of client 200 and the operability of client 200 on a distributed communication network 110 (shown in FIG. 1). For example, processing subsystems allow for initiating and maintaining communications and exchanging data with other networked devices. For the disclosed aspects, processing subsystems of first processing device(s) 220 may include any subsystem used in conjunction with email management application 230 and related engines, routines, algorithms, sub-algorithms, modules, sub-modules thereof.

Client 200 additionally includes a communications module (not shown in FIG. 2) embodied in hardware, firmware, software, and combinations thereof, that enables electronic communications between client 200 and other networks and/or networked devices, such as, cloud computing model 300 and the like. Thus, the communication module may include the requisite hardware, firmware, software and/or combinations thereof for establishing and maintaining a network communication connection with one or more systems, platforms, networks, or the like.

First memory 230 of client 200 stores email management application 230. As previously discussed, the email management application 230 may comprise an off-the-shelf (OTS) email management application 230-1 that includes requisite plug-in/add-on or the like to accommodate access-controlled emails. This, for OTS email management applications 230-1 the application is configured to generate and communicate both conventional emails (i.e., non-access-controlled emails that are communicated to the email recipient's server) and access-controlled emails (i.e., communicated to the cloud computing model 300). Thus, OTS email management application 230-1 is configured with one or more access control options 250. For example, the toolbar 252 may be configured with an access control option 250, which, when activated by the email sender, allows for the email sender to configure the access control rules 320 and generate the access-controlled email. In other embodiments of the invention, the access control option 250 may be embodied in a pop-up window 254, which, by example, may be displayed in response to the email sender performing a predefined action (e.g., engaging the send key/button or the like). It should be noted that selection of the access control option 250 by the email sender will activate one or more APIs to subsequently communicate the email to the cloud computing model 300, as opposed to the domain email server associated with the email recipient's email address.

As also previously discussed, the email management application 230 may comprise a stand-alone, customized, email management application 230-2 that is configured for generating and communicating only access-controlled emails 240. In either the OTS email management application 230-1 or the stand-alone email management application 230-2 the application will be configured to provide the email sender with access control rule options 250 that may be configured on a per-email recipient basis (i.e., each email recipient 402 may have different access control assigned to the same email 240).

User Interfaces (UIs) in the email management application 230 may be configured to present the email sender with various access control rule options 250 (i.e., access control rules 320 and parameters for selected access control rules). The access control rule options 250 may include, but are not limited to, read-only 252, retractable 254, retraction 256 after a defined time period 256-1, redaction 258 of defined email portions 240-1 and the like. The access control rules may apply to the entirety of the email 240 or any portion of the email, such as to one or more email attachments. For example, in the event that the email comprises multiple attachments, the access control rules may apply to all of the attachments or only selected ones of the attachments.

Read-only 252, as used here-in, provides for the email recipient to only read/view the email 240 and not forward the email, print the email, copy/save the email the email to computing memory or the like.

Retractable 256 provides for the email sender to retract (i.e., remove the email from the email recipient's inbox and/or deny the email recipient further access to the email) the email on demand, at any point in time, even after the email has been opened and read by the email recipient. Retraction 256 after a defined time period 256-1 provides for the email 240 to be automatically retracted after expiration of the defined time period 256-1. The email sender may set the time period 256-1 at any length, for example, a short period of time (e.g., 2 minutes) to allow for a one-time reading of the email or an extended period of time (e.g., a day, a week, a month or the like). In this regard, in specific embodiments of the invention, the email sender may configure the access control rule options 250, such that, different email recipients 402 have different defined time periods 256-1 (i.e., one or more of the email recipients 402 may have access to the email for one time period, while one or more other email recipients 402 may have access to the email for a shorter or longer time period).

Redaction 258 allows for the email sender to select specific email portions 240-1 to be not visible (i.e., obfuscated, deleted or the like) to the designated email recipient 402. In this regard, the email sender may designate one or more first email portions 240-1 to be redacted for one or more email recipients and one or more second email portions 240-2 different from the first email portions 240-1 (e.g., mutually exclusive of the first email portions or including part of the first email portion) to be redacted for one or more different email recipients. Moreover, the redaction 258 may have time constraints assigned to it, such that redaction may occur after a defined period time (e.g., the email recipient may view the entire email 240 until expiration of the time period, at which time designated portions 240-1 of the email 240 are redacted) or, alternatively, portions 240-1 or the email 240 may be initially redacted until expiration if the time period, at which time the redaction is removed and the entire email 240 is viewable to the email recipient 402.

The access control rules 320 may be configured to be enforced for different time periods for different email recipients 402. For example, one or more email recipients may be subject to read-only access control for a first time period and one or more other email recipients may be subject to read-only access control for a second time period that is different than the first time period (i.e., mutually exclusive of the first time period or overlapping a portion of the first time period). The access control rules 320 that are enforced for different time periods may apply to the entire email or to different parts of the email including email attachments.

In other embodiments of the invention, the email management application may be configured to invoke rules to determine specific access control rules for an email based on the email recipient (and/or the email recipient belonging to a specific group of users) and/or content of the email. In other words, when the email sender inputs an email recipient address, the email management application may check a database to see if the email recipient (as defined by the email address) is currently mapped to access control rules and apply the access control rules. In other embodiments of the invention, the email management application is configured to read the contents of the email and determine if the contents/subject of the email is subject to access control rules (e.g., includes classified, private, confidential or non-public information) and apply appropriate access controls (e.g., redact the classified, private, confidential or non-public information or the like). For example, in specific embodiments of the invention, the rules may be associated with an email recipient's legal status (e.g., currently subject to legal hold, investigation) or work status (Leave of Absence (LOA), terminated or the like), such that access control rules 320 are mapped to the email recipient's legal or work status.

In other embodiments of the invention, in which the email management application is configured such that access control is limited to read-only 252 and retractable 254 there may be no need for the email management application to provide access control rule options 250 other than selection of the email recipients 402 to which access control applies.

Once the access-controlled email 240 has been generated, including selection of access control options/parameters 250, email management application 230 is configured to communicate the email 240, along with the access control rules 320 (provided for the email header) to the cloud computing model 300.

Additionally, email management application 230 is configured to provide access control rule revision/revocation options 260 that are configured to allow the email sender, at any point in time up until the email has been communicated/downloaded to the client and/or email server, to revise access control rules 262 or revoke access control rules 264 to one or more of the email recipients. Revising access control rules 262 may include, but are not limited to, revising the time period 256-1 for retraction 256 (i.e., shortening, lengthening or eliminating), changing the email portions 240-1 that are subject to redaction 258 (i.e., adding new email portions for redactions, making visible previous redacted email portions and the like) and the like. Revoking access control rules 262 may include, but are not limited to, revoking read-only 252 access control (i.e., allowing the email recipient to store, print and/or forward the email), revoking a previously defined time period 256-1 for retraction 256, revoking all redacted portions 240-1 of the email 240 and the like.

Referring to FIG. 3, a block diagram is depicted of a cloud computing model 300 configured for applying access control to emails, in accordance with embodiments of the present invention. In addition to providing more details of the cloud computing model 300, FIG. 3 highlights various alternative embodiments of the invention. The cloud computing model 300 includes cloud storage 310 that is configured to receive and host email 240 communicated from the email sender's host. As previously discussed, the email may contain, within the header of the email or the, access control rules 320 specific to each email recipient 402.

Cloud processing device(s) 320 are implemented to perform access control rule determination 340. As previously discussed, the access control may be determined/identified via email determination 342, in which information in the header or the body of the email 240 identifies the access control rules 320 and parameters associated therewith. In other embodiments of the invention, in addition to or in lieu of the access control rules 320 included in the email 240, cloud-based determination 344 may be performed to determine one or more access control rules for email recipients 402. For example, access control rules database(s) 350 may be stored in cloud storage 310 or otherwise is accessible to cloud processing devices 312. The database 350 includes a mapping of access control 320 to email recipients 402 and/or email content 452. In one specific embodiment, a first database 350 is accessed that maps a data restriction classification to each email recipient to identify the data restriction classification of each email recipient, and a second database 350 is accessed that maps email content sensitivity classifications to the data restriction classifications to identify sensitivity classifications of content in the email. In response, portions of the email are identified as requiring redaction based on the identified (i) data restriction classifications of each email recipient, and (ii) the sensitivity classifications of content in the mail.

In response to determining/identifying the access control rules 320, the cloud processing devices 312 of the cloud computing model 300 perform access control rule application 360 to apply the access control rules 320 to the email 240 on a per-email recipient basis. For example, content is redacted, timers applied and the like. In addition, the cloud processing devices 312 perform access control indicator generation 370 to generate/select appropriate access control indicators 330 for the email. Indicators 330 may include email banners 330-1 that are inserted into the body of the email to visually indicate that the email is subject to access control and the specific type(s) of access control. Additionally, indicators 330 may include running timers/clocks 330-2 that dynamically indicate the time until the email is retracted (i.e., expires or is no longer accessible to the email recipient). Since individual email recipients 402 may have access control rules 320 that are specific to the email recipient 402, the indicators 330 may also be specific to one or more email recipients 402.

Cloud storage 310 may additionally include client monitoring module 380 that is executable by the cloud processing device(s) 320 and is configured to monitor 382 the email recipient's client 400 for predetermined actions 386 in response to the email recipient opening the email notification and accessing 384 the email 240. The actions 386 may include any predefined action which may result in the email recipient violating or attempting to violate the access control rules (such as enabling a “print screen” function or the like). Such actions may include, but are not limited to, engaging the “Control C” function, engaging the “Right Click” function (evident of copy and paste function), accessing a command line of the email, pasting an image of the email onto a desktop or into a web application, determining a data match (i.e., exact match or key words match) between content of the email and data in other client applications (e.g., notes application, presentation application or the like), disabling predetermined functions in the client, using, searching for and/or downloading certain applications that bypass Operating System (OS)-level security, connecting a Universal Serial Bus (USB) device, opening a short-range wireless file transfer dialog box or the like. In response to detecting one or more of the actions 386 (e.g., a pattern or the actions), the module 380 is configured to perform access privilege revision/revocation 388 to revise or revoke access privileges provided to the email recipient (e.g., immediately retract the email 240 and deny the email recipient 402 any further access to the email 240).

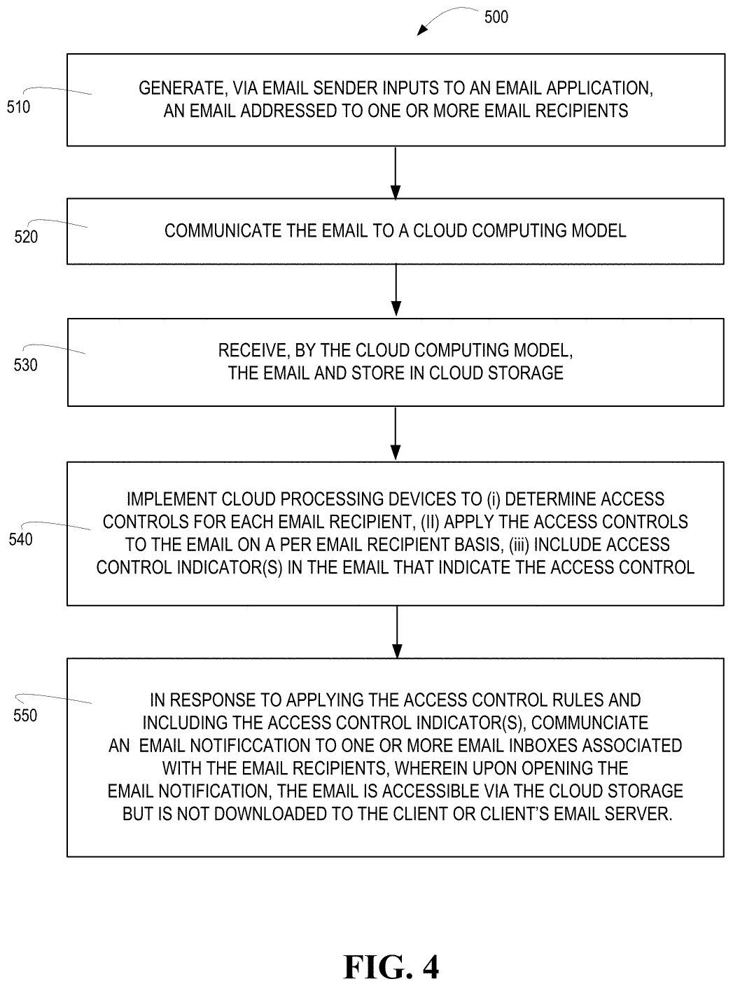

Referring to FIG. 4, a flow diagram is depicted of a method 500 for controlling access to emails, in accordance with embodiments of the present invention. At Event 510, an email sender provides inputs to an email management application that generates an email addressed to one or more email recipients. In specific embodiments of the method, in which the email management application is an OFS email management application configured for access controlled emails the email sender will provide an input, either prior to generating the email, during generation or after generating, that designates the email for access control. Moreover, in specific embodiments of the invention, in which the access control rules are identified by the email sender, the email sender will provide inputs, either prior to generating, during generation or after generating the email, that define the access control rule options and any parameters associated with defined access control rules.

At Event 520, the email is communicated to a cloud computing model/platform, in lieu of communicating the email to email servers associated with the email recipient's domain. As previously discussed, if the email management application is a stand-alone email application specifically designed for access-controlled emails, the application will be configured to communicate all emails to the cloud computing model. However, if the email management application is an OFS email application that has been retrofitted to allow for access controlled emails, the input by the email sender that designates the email for access control will activate designated APIs to communicate the email to the cloud computing model, as opposed to the email servers associated with the email recipient's domain. It should also be noted that in the event that the email sender has configured the email such that a portion of the email recipients receive an access-controlled email and another portion of the email recipients receive a standard email that is not subject to access control, the email may be configured to be sent to the cloud computing model for all recipients (with no access control rules being applied for the email recipients not subject to access control) or, in other embodiments, the email will be sent to both the cloud computing model and, for email recipient's not subject to access control, the email servers associated with the email recipient's domain.

At Event 530, the cloud computing model receives the email and stores/hosts the email in cloud storage. At Event 540, cloud processing devices are implemented to (i) determine access control rules for each email recipient, (ii) apply the determined access control rules to the email on a per-email recipient basis, and (iii) include one or more access control indicators in or with the email that indicate the access control under which the email is subjected to. In specific embodiments of the invention, determination of the access control rules provides for identifying the access control rules included within the email (i.e., access control rules defined by the email sender). In other specific embodiments of the invention, determination of one or more of the access control rules may occur at the cloud computing model by accessing a database that maps access control rules to email recipients or groups of email recipients and, if one of the email recipients included in the mail are determined to be mapped to one or more access control rules, the access control rules are applied to the email being sent to the email recipient.

Including one or more access control indicators in the email may include inserting a banner in the body of the email that indicates that the email is subject to access control and informs the email recipient as to the specifics/types of the access control. In other embodiments of the method, the one or more indicators may include inserting a running/dynamic time-keeper/clock in the body of the email that indicates the time remaining until the email is retracted. In other specific embodiments of the method, the one or more access control indicators may be highlighted and obfuscated portions of the body email that have been redacted. In still further embodiments of the method, the one or more control indicators may include a flag which is configured to be presented within a designated column of the email recipient's email management application, which designates the email as being under access control rules.

At Event 550, in response to applying the requisite access control rules to the email on a per-email recipient basis and adding applicable access control indicators to the email, an email notification is communicated to one or more email inboxes, each email inbox associated with a respective one of the email recipients. Wherein, upon opening the email notification, the email is accessible to the email recipient via the cloud storage without downloading the email (or provide the capability to download the email) to the email recipient's client or the email server associated with the email recipient's domain. In this regard, since control of the email remains at all times in the cloud, the email can be limited to read-only status, retractable on-demand by the email sender and access control rules can be revised or revoked on-demand or by pre-defined rules as required.

Thus, as described in detail above, present embodiments of the invention include systems, methods, computer program products and/or the like for access control of emails. Specifically, the present invention applies access control rules on a per-email recipient basis at a cloud computing model, such that the emails are only accessible to the email recipient via the cloud. Thus, the emails do exist on the email server or client of the email recipient. Access rules may include, but are not limited to, (i) read-only, (ii) retractable on demand by the email sender, (iii) retraction after expiration of a predefined time period, (iv) redaction of predefined portions of the email and the like. The email appears in the email recipient's inbox with one or more identifiers that indicate that the email is subject to access control. Moreover, since access is controlled within the cloud computing model, access rules may dynamically be revised by the email sender after the email has been sent to accommodate the needs of the email sender.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for controlling access to electronic mail (email), the system comprising;
an email management application configured to:
provide for an email sender to generate an email addressed to one or more email recipients, and
communicate the email to a cloud computing model; and
the cloud computing model comprising cloud storage and one or more cloud processors in communication with the cloud storage, wherein the cloud computing model is configured to:
receive and store in the cloud storage the email communicated from the email management application, and
implement the one or more cloud processors to:
determine access control rules for the email on a per-email recipient basis, wherein the access control rules include determining portions of the email to redact, where the portions of the mail to be redacted are determined on a per-email recipient basis,
apply the access controls rules to the email including redacting the determined portions of the email on a per-email recipient basis,
include one or more access control indicators in the email, wherein the one more control indicators indicate to the email recipients that the email is subject to one or more access controls, and
in response to applying the access control rules to the email and including the one or more access control indicators, communicate an email notification associated with the email to one or more email inboxes, each of the one or more email inboxes associated with an email address of one of the one or more email recipients,
wherein, in response to the one or more email recipients opening the email notification from their associated inbox, each email recipient is able to view the email via the cloud storage in accordance with the email recipient-specific access controls rules and the email is not permanently stored at any (i) client of the email recipient, and (ii) email server associated with a domain of the email recipient.

2. The system of claim 1, wherein the access controls rules include designation of the email as read-only, wherein read-only includes not being able to forward or print the email.

3. The system of claim 1, wherein the access control rules include designation of the email as at least one selected from the group consisting of (i) retractable on-demand by the email sender, and (ii) retraction after expiration of a predetermined time period.

4. The system of claim 1, wherein the cloud computing model is configured to implement the one or more cloud processors to include one or more access control indicators in the email, is further configured to include a running time keeper as one of the access control indicators that is configured to dynamically indicate a time before expiration of the predetermined time period.

5-6. (canceled)

7. The system of claim 1, wherein the cloud computing model that is configured to implement the one or more cloud processors to determine access control rules for the email on a per-email recipient basis are further configured to:
determine the portions of the email to be redacted on a per-email recipient basis by:
accessing (i) a first database that stores a data restriction classification for each email recipient to identify the data restriction classification of each email recipient, and (ii) a second database that stores email content sensitivity classifications to identify sensitivity classifications of content in the email, and
determining the portions of the email on a per-email recipient basis based on the identified (i) data restriction classifications of each email recipient and (ii) the sensitivity classifications of content in the mail.

8. The system of claim 1, wherein the email management application is further configured to provide for a graphical user interface that includes a selectable access control option, wherein selection of the access control option provides for the email to be communicated to the cloud computing model instead of one or more email servers associated with domains of the one or more email recipients.

9. The system of claim 8, wherein the email management application is further configured to:
in response to the email sender selecting the access control option, presenting one or more user interfaces configured for selecting access control rules on a per-email recipient basis, and
in response to the email sender selecting the access control rules, including the access control rules as metadata in a header of the email prior to communicating the email to the cloud computing model.

10. The system of claim 1, wherein the cloud computing model that is configured to:
in response to the email recipient accessing the email from the cloud storage, monitor the actions performed by the email recipient on the client, and
in response to determining that one or more of the monitored actions are in conflict with the access control rules, revoke the email recipient's access privilege to the email.

11. The system of claim 1, wherein the email management application is further configured to:
provide for the email sender to revise or revoke the access control rules applied to the email, and
in response to the email sender revising or revoking the access controls, communicate commands to the cloud computing model that are configured to revise or revoke the access control rules.

12. The system of claim 1, wherein the email management application is a stand-alone access control email management application configured for only communicating access controlled emails to the cloud computing model.

13. A computer-implemented method for controlling access to emails, the computer-implemented method is executed by one or more processing devices and comprising:
generating, within an email management application via email sender inputs, an email addressed to one or more email recipients;
communicating the email to a cloud computing model;
receiving, by the cloud computing model, the email and storing the email in cloud storage;
implementing one or more cloud processors to (i) determine access control rules for the email on a per-email recipient basis, wherein the access control rules include determining portions of the email to redact, where the portions of the mail to be redacted are determined on a per-email recipient basis, and (ii) apply the access controls rules to the email including redacting the determined portions of the email on a per-email recipient basis,
including one or more access control indicators in the email, wherein the one more control indicators indicate to the one or more email recipients that the email is subject to one or more access controls; and
in response to applying the access control rules to the email and including the one or more access control indicators, communicating an email notification associated with the email to one or more email inboxes, each of the one or more email inboxes associated with an email address of one of the one or more email recipients,
wherein, in response to the one or more email recipients opening the email notification from their associated inbox, each email recipient is able to view the email via the cloud storage in accordance with the email recipient-specific access controls rules and the email is not and cannot be permanently stored at any (i) client of the email recipient, and (ii) email server associated with a domain of the email recipient.

14. The computer-implemented method of claim 13, wherein implementing one or more cloud processors to determine access control rules for the email on a per-email recipient basis further defines the access controls rules as at least one selected from the group consisting of (i) read-only, (ii) retractable on-demand by the email sender, and (iii) retraction after expiration of a predetermined time period.

15. The computer-implemented method of claim 13, wherein generating the email further comprises:
presenting, within the email management application, for a selectable access control option;
receiving an input, by the email sender, that selects the access control option;
in response to receiving the input that selects the access control option, (i) configuring the email for communication to the cloud computing model instead of one or more email servers associated with domains of the one or more email recipients, and (ii) presenting, within the email management application, selectable access control rules; and
in response to the email sender selecting the access control rules for each of the one or more email recipients, including the access control rules as metadata in a header of the email prior to communicating the email to the cloud computing model.

16. The computer-implemented method of claim 13, further comprising:
in response to the email recipient accessing the email from the cloud storage, monitoring the actions performed by the email recipient on the client; and
in response to determining that one or more of the monitored actions are in conflict with the access control rules, revoking the email recipient's access privilege to the email.

17. A computer program product including a non-transitory computer-readable medium, the non-transitory computer-readable medium comprising:
a first set of codes for causing a computer to receive email sender inputs that generate, within an email management application, an email addressed to one or more email recipients;
a second set of codes for causing a computer to communicate the email to a cloud computing model;
a third set of codes for causing a computer to receive, by the cloud computing model, the email and store the email in cloud storage;
a fourth set of codes for causing a computer to implement one or more cloud processors to (i) determine access control rules for the email on a per-email recipient basis, wherein the access control rules include determining portions of the email to redact, where the portions of the mail to be redacted are determined on a per-email recipient basis, and (ii) apply the access controls rules to the email including redacting the determined portions of the email on a per-email recipient basis;
a fifth set of codes for causing a computer to include one or more access control indicators in the email, wherein the one more control indicators indicate to the one or more email recipients that the email is subject to one or more access controls, and
a sixth set of codes for causing a computer to, in response to applying the access control rules to the email and including the one or more access control indicators, communicate an email notification associated with the email to one or more email inboxes, each of the one or more email inboxes associated with an email address of one of the one or more email recipients,
wherein, in response to the one or more email recipients opening the email notification from their associated inbox, each email recipient is able to view the email via the cloud storage in accordance with the email recipient-specific access controls rules and the email is not and cannot be permanently stored at any (i) client of the email recipient, and (ii) email server associated with a domain of the email recipient.

18. The computer program product of claim 17, wherein the fourth set of codes are further configured to cause the computer to implementing one or more cloud processors to determine access control rules for the email on a per-email recipient basis, wherein the access controls rules are at least one selected from the group consisting of (i) read-only, (ii) retractable on-demand by the email sender, and (iii) retraction after expiration of a predetermined time period.

19. The computer program product of claim 17, wherein the first set of codes is further configured to cause the computer to (i) present, within the email management application, for a selectable access control option, (ii) receive an input, by the email sender, that selects the access control option, and (iii) in response to receiving the input that selects the access control option, (a) configuring the email for communication to the cloud computing model instead of one or more email servers associated with domains of the one or more email recipients, and (b) presenting, within the email management application, selectable access control rules; and (iv) in response to the email sender selecting the access control rules for each of the one or more email recipients, including the access control rules as metadata in a header of the email prior to communicating the email to the cloud computing model.

20. The computer program product of claim 17, further comprising:
a seventh set of codes for causing a computer to, in response to the email recipient accessing the email from the cloud storage, monitor the actions performed by the email recipient on the client; and
an eighth set of codes for causing a computer to, in response to determining that one or more of the monitored actions are in conflict with the access control rules, revoke the email recipient's access privilege to the email.
